(19) United States
(12) Patent Application Publication
(10) Pub. No.: US 2011/0261979 A1
(43) Pub. Date: Oct. 27, 2011

(54) DIAPHRAGM AND CONDENSER MICROPHONE USING SAME

(76) Inventors: Bin YANG, Shenzhen (CN); Rui Zhang, Shenzhen (CN)

(21) Appl. No.: 12/978,577

(22) Filed: Dec. 26, 2010

(30) Foreign Application Priority Data
Apr. 27, 2010 (CN) 201010163721.6

(51) Int. Cl. H04R 1/00; G10K 13/00

(52) U.S. Cl. 381/174; 181/158

(57) ABSTRACT

A diaphragm is disclosed. The diaphragm includes a vibrating member, a projection extruding from a periphery of the vibrating member, a supporting member surrounding the vibrating member. A first gap is formed between the vibrating member and the supporting member. The supporting member includes a supporting girder surrounding and separated from the projection. A torsion girder is connected to the projection and a fixing girder is parallel to the torsion girder. A second gap is defined between the fixing girder and the torsion girder.

### BACKGROUND OF THE INVENTION

1. Field of the Invention

The present invention generally relates to the art of microphones and, more particularly, to a diaphragm used in a microphone manufactured by MEMS technology.

2. Description of Related Art

Silicon based condenser microphones, known as acoustic transducers, have been researched and developed for more than 20 years. Because of potential advantages in miniaturization, performance, reliability, environmental endurance, low cost, and mass production capability, silicon based microphones are widely recognized to be the next generation product to replace electret condenser microphones (ECM) that has been widely used in communication devices, multimedia players, and hearing aids.

A related silicon based condenser microphone comprises a backplate having a planar plate with a plurality of perforations therein, and a diaphragm parallel and opposed to the backplate for forming a capacitor. The diaphragm can be activated to move along a direction perpendicularly to the planar plate of the backplate.

The diaphragm is very important to the performance of the silicon based condenser microphone. In general, the diaphragm is supported by some fixing members distributing at the periphery of the diaphragm symmetrically. But it is difficult to release the stress of the diaphragm of such structure, which influences the sensitivity and coherence of the microphone. The present invention is provided to solve the problems mentioned above.

### BRIEF DESCRIPTION OF THE DRAWINGS

FIG. 1 is an isometric view of a diaphragm in accordance with a first embodiment of the present invention;

FIG. 2 is an isometric view of a diaphragm in accordance with a second embodiment of the present invention.

### DETAILED DESCRIPTION OF EXEMPLARY EMBODIMENTS

Reference will now be made to describe the exemplary embodiments of the present invention in detail.

Electronic devices, especially portable devices, sucha as mobile phones, generally use condenser microphones for receiving sound waves and then converting the sound waves to electrical signals. A condenser microphone comprises a substrate having a through cavity, a backplate connected to the substrate and defining a plurality of sound holes, and a diaphragm opposed to the backplate for forming a capacitor. The diaphragm will be described in detail hereinafter.

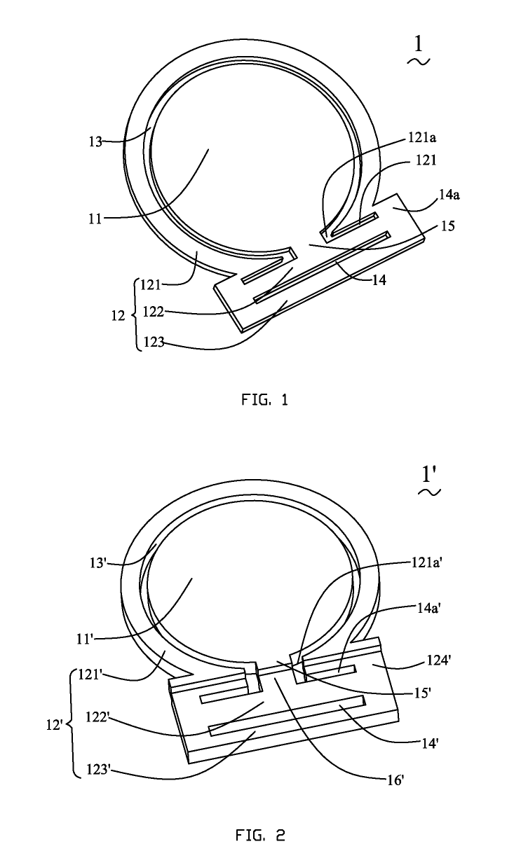

In a first embodiment, referring to FIG. 1, the diaphragm 1 comprises a vibrating member 11, a projection 15 extruding from a periphery of the vibrating member 11, a supporting member 12 surrounding and connected to the vibrating member by the projection 15. A first gap 13 is formed between the vibrating member 11 and the supporting member 12. The supporting member 12 comprises a supporting girder 121 surrounding the vibrating member 11, a torsion girder 122 connected to the projection 15, a fixing girder 123 parallel to the torsion girder 122, and a second gap 14 formed between the fixing girder 123 and the torsion girder 122. Ends of the supporting girder 121, the torsion girder 122 and the fixing girder 123 are connected by a connecting beam 124. For enhancing the elasticity of the torsion girder 122, a third gap 14a is formed between the end of the supporting girder 121 and the torsion girder 122.

The projection 15 and the torsion girder 122 is coplanar to each other. For avoiding interference between the supporting girder 121 and the projection 15, the supporting girder 121 defines an opening 121a. The projection 15 extends from the vibrating member 11 and passes through the opening 121a to connect to the torsion girder 122.

Referring to FIG. 2, the diaphragm 1′ comprises a vibrating member 11′, a projection 15′ extruding from a periphery of the vibrating member 11′, a supporting member 12′ surrounding and connected to the vibrating member by the projection 15′. A first gap 13′ is formed between the vibrating member 11 and the supporting member 12′. The supporting member 12′ comprises a supporting girder 121′ surrounding the vibrating member 11′, a torsion girder 122′ connected to the projection 15′, a fixing girder 123′ parallel to the torsion girder 122′, and a second gap 14′ formed between the fixing girder 123′ and the torsion girder 122′. Ends of the supporting girder 121′, the torsion girder 122′ and the fixing girder 123′ are connected by a connecting beam 124′. For enhancing the elasticity of the torsion girder 122′, a third gap 14a′ is formed between the end of the supporting girder 121′ and the torsion girder 122′. For avoiding interference between the supporting girder 121′ and the projection 15′, the supporting girder 121′ defines an opening 121a′. The projection 15′ extends from the vibrating member 11′ and passes through the opening 121a′ to connect to the torsion girder 122′. A step 16′ is additionally formed between the projection 15′ and the torsion girder 122′. Another words, a plane determined by the torsion girder 122′ and the fixing girder 123′ is not coplanar to a plane determined by the supporting girder 121′.

As the supporting member 12′ comprises a supporting girder 121′ surrounding the vibrating member 11′, a torsion girder 122′ connected to the projection 15′, a fixing girder 123′ parallel to the torsion girder 122′, and a second gap 14′ formed between the fixing girder 123′ and the torsion girder 122′, stress of the diaphragm will be easily released by the torsion girder 122′. A step 14′ between the projection 15′ and the torsion girder 122′ will promote the release of the stress. By virtue of the structures described above, sensitivity and coherence of the microphone is improved.

While the present invention has been described with reference to specific embodiments, the description of the invention is illustrative and is not to be construed as limiting the invention. Various of modifications to the present invention can be made to the exemplary embodiments by those skilled in the art without departing from the true spirit and scope of the invention as defined by the appended claims.

What is claimed is:

1. A diaphragm comprising:
a vibrating member;
a projection extruding from a periphery of the vibrating member;
a supporting member surrounding the vibrating member;
a first gap formed between the vibrating member and the supporting member; wherein
the supporting member comprises
a supporting girder surrounding and separated from the projection;
a torsion girder connected to the projection;
a fixing girder parallel to the torsion girder;
a second gap defined between the fixing girder and the torsion girder.

2. The diaphragm as described in claim 1, wherein the supporting member further defines a connecting beam connecting ends of the supporting girder and the torsion girder.

3. The diaphragm as described in claim 1, wherein the supporting member further defines a connecting beam connecting ends of the fixing girder and the torsion girder.

4. The diaphragm as described in claim 1, wherein the vibrating member, the projection and the torsion girder is coplanar to each other.

5. The diaphragm as described in claim 1, wherein a step is defined between the vibrating member and the torsion girder.

6. The diaphragm as described in claim 1, wherein the supporting girder defines an opening and the projection passes through the opening.

7. The diaphragm as described in claim 1, wherein a third gap is defined between an end of the supporting girder and the torsion girder.

8. A diaphragm for a condenser microphone, comprising:
a vibrating member;
a supporting member including a supporting girder surrounding and separated from the vibrating member and a stress releasing member extending from the supporting girder, wherein
the stress releasing member and the supporting member corporately form a closed ring surrounding the vibrating member.

9. The diaphragm as described in claim 8, wherein the stress releasing member comprises:
a projection extruding from a periphery of the vibrating member;
a first gap formed between the vibrating member and the supporting member;
a torsion girder connected to the projection;
a fixing girder parallel to the torsion girder;
a second gap defined between the fixing girder and the torsion girder,

10. The diaphragm as described in claim 9, wherein the supporting member further defines a connecting beam connecting ends of the supporting girder and the torsion girder.

11. The diaphragm as described in claim 9, wherein the supporting member further defines a connecting beam connecting ends of the fixing girder and the torsion girder.

12. The diaphragm as described in claim 9, wherein a step is defined between the vibrating member and the torsion girder.

13. The diaphragm as described in claim 9, wherein the supporting girder defines an opening and the projection passes through the opening.

14. The diaphragm as described in claim 9, wherein a third gap is defined between an end of the supporting girder and the torsion girder.

15. A condenser microphone comprising:
a substrate having a through cavity;
a backplate connected to the substrate and defining a plurality of sound holes;
a diaphragm opposed to the backplate for forming a capacitor and comprising:
a vibrating member;
a projection extruding from a periphery of the vibrating member;
a supporting member surrounding the vibrating member;
a first gap formed between the vibrating member and the supporting member; wherein
the supporting member comprises
a supporting girder surrounding and separated from the projection;
a torsion girder connected to the projection;
a fixing girder parallel to the torsion girder;
a second gap defined between the fixing girder and the torsion girder.
